(19) United States
(12) Patent Application Publication
(10) Pub. No.: US 2011/0175460 A1
(43) Pub. Date: Jul. 21, 2011

(54) DC CURRENT BREAKER

(75) Inventors: Urban Âström, Saxdalen (SE); Lars Liljestrand, Vasteras (SE); Victor Lescale, Ludvika (SE); Magnus Backman, Vasteras (SE)

(73) Assignee: ABB TECHNOLOGY AG, Zurich (CH)

(21) Appl. No.: 12/997,025

(22) PCT Filed: Jun. 10, 2008
(86) PCT No.: PCT/EP2008/057206

§ 371 Date: Feb. 25, 2011

(51) Int. Cl. H02B 1/24

(52) U.S. Cl. 307/112

(57) ABSTRACT

A device for breaking DC currents exceeding 2500 A has a resonance circuit connected in parallel with an interrupter and a surge arrester connected in parallel with the resonance circuit. The resonance circuit has a series connection of a capacitor and an inductance. The relationship of the capacitance in μF to the inductance in μH of the resonance circuit is ≧1.

### TECHNICAL FIELD OF THE INVENTION AND BACKGROUND ART

The present invention relates to a device configured to break DC currents exceeding 2500 A flowing in a first current path and transfer said DC currents to an alternative second current path, said device comprising:
at least one interrupter to be arranged in said first current path and having contacts movable with respect to each other from a closing to an opening position of the interrupter for breaking a current flowing therethrough,
a resonance circuit connected in parallel with said interrupter and comprising a capacitor and an inductance connected in series and configured to create an oscillating current superimposed on said DC current for creating a zero-crossing of the current flowing through the interrupter, thereby enabling breaking of this current when said contacts are moved apart, and
a surge arrester connected in parallel with said resonance circuit and configured to start to conduct when the voltage across said interrupter has reached a certain value upon movement of said contacts apart and to conduct until said DC current has been commutated to said alternative second current path connected to said first current path as a consequence of the presence of said voltage across said interrupter in said first current path.

Such devices may be used in and be adapted to any conceivable application where it is necessary to be able to break a high DC current flowing in a first current path and to transfer the DC current to an alternative second current path, in which this is mostly, but not exclusively, to be carried out upon occurrence of a failure in a plant, equipment or the like handling or utilizing a DC current exceeding 2500 A. However, it could for instance also be used during scheduled maintenance. For being able to break the current through the interrupter it is essential that a zero-crossing of that current is obtained within a restricted time during which the interrupter may take care of the arc created between its contacts when moving them apart. Thus, it is necessary to design the resonance circuit so that the amplitude of the oscillating current superimposed on the DC current will early enough be high enough for obtaining said zero-crossing.

For illuminating but not in any way restricting the invention an application of a device of the type defined in the introduction as a so called metallic return transfer breaker in a plant for transmitting electric power through High Voltage Direct Current (HVDC) will now be briefly explained while referring to FIGS. 1-3. This plant has two converter stations 100, 101 with converters or converter valves 102-105 for converting direct voltage into alternating voltage and conversely. The stations are interconnected by a direct voltage line 106 having two pole conductors 107, 108. Alternating current (AC) lines connected to each converter station are not shown. During normal operation of the plant a DC current is flowing in one pole conductor 107 from the station 100 to the station 101 and then returns to the station 100 through the pole conductor 108.

When a failure occurs in one pole of such a plant the converters of that pole will block and stop the pole current. The current will then use the ground as return path, which is illustrated in FIG. 2 for the case that the pole with the pole conductor 108 or equipment connected therewith has failed. A device of the type defined in the introduction is arranged in this ground return path 111 as a so-called metallic return transfer breaker 109. The related power of HVDC has increased during the past, so that such a metallic return transfer breaker has for some applications to be designed for DC currents exceeding 2500 A, such as in the order of 4000 A. This metallic return transfer breaker or device configured to break such DC currents is arranged for avoiding having a current in the ground for a longer time and obtain a commutation of the current from the ground path to a metallic return path 112 as illustrated in FIG. 3. The very high inductance between the two paths makes the commutation difficult.

In known devices different from the type defined in the introduction by being configured to break DC currents below 2500 A a passive resonance circuit, i.e. a resonance circuit having a capacitor and an inductor and no type of control, has been used. Such a passive resonance circuit is attractive from the cost point of view and by being simple and reliable. However, known such devices with a passive resonance circuit have not been any option for devices configured to break DC currents exceeding 2500 A, since they have not been able to create said oscillating current having an amplitude being high enough for enabling breaking of such high currents. Known devices of the type defined in the introduction have therefore been constructed as shown in FIG. 4. Such a device has an interrupter 1′ and a resonance circuit 2′ connected in parallel therewith. The resonance circuit has a capacitor 3′ and an inductance in the form of an inductor 4′ connected in series. The resonance circuit is active and has a capacitor charger 5′ adapted to precharge the capacitor 3′ to for instance 20 kV. The resonance circuit also comprises a so called closing switch 6′ connected in series with the capacitor and the inductor and configured to be open when the interrupter is in a closed conducting state and to close after a specific arcing time of the interrupter. Such an active resonance circuit has made it possible to obtain a current zero-crossing necessary for breaking DC-currents exceeding 2500 A, such as in the order of 4000 A flowing through the interrupter.

### SUMMARY OF THE INVENTION

The object of the present invention is to provide a device configured to break DC currents exceeding 2500 A of the type defined in the introduction being improved in at least some aspect with respect to such devices already known.

This object is according to the invention obtained by providing such a device in which the relationship of the capacitance in μF to the inductance in μH of said resonance circuit is ≧1.

This constitutes a totally new approach to design the resonance circuit of a device of this type resulting in major advantages. It is known that there is a maximum resonance frequency of a resonance circuit in a device of this type, above which the interrupter may not cool the arc created upon interrupting fast enough. The resonance frequency is

$$\frac{1}{2 π} \sqrt{\frac{1}{LC} .}$$

For reducing the costs for the capacitor of the resonance circuit it has until now been focused on selecting a rather high inductance L for remaining below said maximum resonance frequency. This has typically meant said relationship of the capacitance in μF to the inductance in μH being in the order of ⅓. However, the present inventors have realized that a substantially increased value of this relationship is very favourable. The amplitude of said oscillating current created by said resonance circuit is in fact proportional to (C/L)^{1/2}, so that an increase of this relationship will make it easier to break higher currents. Furthermore, the rate of rise for the transient recovery voltage in the interrupter is proportional to 1/C, so that a larger capacitance will reduce the rate of rise of the recovery voltage for a given DC current. These two properties which are important for breaking high currents are also combined with the reducing effect of an increased capacitance of the resonance circuit upon the resonance frequency thereof.

This means in fact that a device according to the invention may be used to break DC currents being substantially higher than known devices having a passive resonance circuit, so that such a device may be configured to break DC currents exceeding 2500 A.

According to an embodiment of the invention said relationship is ≧2. It has turned out that a relationship exceeding 2 is very favourable for a device of this type making it possible to reliably break current exceeding 2500 A, such as in the order of 5000 A, without any need to use any active resonance circuit of the type described above. The relationship may then according to another embodiment of the invention be ≦8 and particularly between 2 and 8. A relationship above 8 may lead to a capacitor being too costly while leading to a current breaking capacity not asked for.

According to another embodiment of the invention said relationship is between 3 and 5, preferably between 2.5 and 3.5, which has turned out to result in a favourable combination of operation properties and costs of a device of this type.

According to another embodiment of the invention said inductance of the resonance circuit is formed solely by the self inductance of a conductor used to connect said capacitor in parallel with said interrupter. The choice of the relationship of the capacitance to the inductance in the resonance circuit of the device according to the present invention to be high makes it possible to use only the self inductance of said conductor as inductance for the resonance circuit, so that the costs of a separate inductor will be saved. This also makes it possible to obtain a high amplitude of said oscillating current without excessively increasing the capacitance, since this amplitude will increase with a reduced inductance.

According to another embodiment of the invention the inductance of the resonance circuit is between 5 and 35 μH or between 15 and 25 μH, which are favourable values for an inductance of said resonance circuit for obtaining said relationship according to the invention. These are also inductances that may be obtained by the self inductance of said conductor. The self inductance of a conductor in resonance circuits of this type is typically about 1 μH per meter conductor, and such a conductor has typically a length resulting in a self inductance thereof within these ranges.

According to another embodiment of the invention the capacitance of the resonance circuit is between 40 and 80 μF or between 50 and 70 μF. It has turned out that a capacitance within these limits will be large enough for obtaining a reduction of the rate of rise of said recovery voltage for a given DC current aimed at and still enable obtaining of said favourable relationship thereof to the inductance of the resonance circuit for enabling breaking of high DC-currents thanks to a high amplitude of said oscillating current superimposed on the DC current. The costs for a capacitor or capacitor bank with such a capacitance will also stay within a limit being well acceptable.

According to another embodiment of the invention said inductance of the resonance circuit is between 15 and 25 μH and said relationship is between 2.5 and 3.5. This has turned out to result in favourable characteristics of a device according to the invention appearing from the discussion above.

According to another embodiment of the invention said resonance circuit is purely passive. The choice of said relationship of the capacitance to the inductance of the resonance circuit in the device according to the present invention makes it possible to design said resonance circuit to be purely passive and still to be able to obtain a reliable breaking of high DC currents through the interrupter and transfer thereof to said alternative second current path.

According to another embodiment of the invention the device has only one said interrupter connected in parallel with said resonance circuit. “One interrupter” means in this context an interrupter having only one arc chamber in which an arc is created upon interruption. Such a simple interrupter saving costs may be used in most applications for reliably breaking DC currents being as high as about 5000 A.

According to another embodiment of the invention the device has two or more said interrupters connected in series, and the series connection of said interrupters is connected in parallel with said resonance circuit. “Two or more said interrupters connected in series” covers the case of two separate interrupters connected in series, but also the case of an interrupter having a plurality of chambers connected in series, so that a plurality of arcs connected in series may be created upon interruption. This embodiment is more costly than the embodiment having only one interrupter, but it results in a higher total arc voltage, a higher probability to create a voltage step starting the oscillation and an increased withstand capability during the transient recovery phase of the interrupter. This also means that the initiation of the oscillation of the superimposed current may be more efficient, so that a zero-crossing of this current may be obtained by using a lower capacitance than with only one interrupter.

According to another embodiment of the invention said resonance circuit comprises a switch connected in series with said capacitor and said inductance and configured to be open when said interrupter is in a closed conducting state, and the device further comprises means configured to control said switch to close and by that to close said resonance circuit with a delay with respect to said opening of said interrupter. Accordingly, this embodiment has an active resonance circuit, but without a capacitor charger, and it may be used for breaking very high currents, such as in the order of 7000 A. By synchronizing the operation of the closing switch to close with a certain delay with respect to the opening of the interrupter it is possible to create a rather well defined voltage step that efficiently initiates the current oscillation.

The invention also relates to a use of a device according to the present invention for breaking a DC current I, in which 2500 A≦I≦7000 A, preferably for I≧4500 A. The advantages of such a use appear clearly from the discussion above of the devices according to different embodiments of the present invention.

The invention also relates to a plant for transmitting electric power through High Voltage Direct Current (HVDC) having in at least one converter station thereof a device according to the present invention for commutating a DC current flowing in said first current path of said plant into an alternative second current path thereof. This constitutes a preferred application of a device according to the present invention. It is then particularly preferred to arrange said device in a plant having a bipole direct current line interconnecting two said converter stations thereof and arranging the device in a ground return path used by said DC current upon failure in connection with one of the two poles of the direct current line and to commutate the DC current to go through a metallic return path between said stations.

Further advantages and advantageous features of the present invention will appear from the following description of embodiments of the invention.

### BRIEF DESCRIPTION OF THE DRAWINGS

With reference to the appended drawings, below follows a specific description of embodiments of the invention cited as examples.

In the drawings:

FIGS. 1-3 are simplified views illustrating a possible application of a device according to the present invention,

FIG. 4 is a simplified view of a device according to the prior art,

FIGS. 5-7 are views similar to the view in FIG. 4 of devices according to a first, second and third, respectively, embodiment of the present invention,

FIGS. 8-11 are simplified views illustrating the operation of a device according to the present invention when breaking a DC current flowing in a first current path and transferring this current to an alternative second current path,

FIG. 12 is a diagram of an oscillating current created in a resonance circuit in a device according to the present invention versus time for resonance circuits with a fixed capacitance and different inductances,

FIG. 13 is a diagram of an oscillating current created in a resonance circuit in a device according to the present invention versus time for resonance circuits for a fixed resonance frequency but with varying capacitances and inductances, and

FIG. 14 is a diagram of the inductance versus the capacitance for a fixed maximum resonance frequency illustrating the area within which capacitances and inductances of the resonance circuit in a device according to the present invention may be selected.

### DETAILED DESCRIPTION OF EMBODIMENTS OF THE PRESENT INVENTION

FIG. 5 illustrates a device according to a first embodiment of the present invention comprising one single interrupter 1 to be arranged in a first current path 8 and having contacts 9, 10 movable with respect to each other from a closing to an opening position of the interrupter for breaking a current flowing therethrough. The device has also a resonance circuit 2 connected in parallel with the interrupter and comprising a capacitor 3 and an inductance 4 formed solely by the self inductance of a conductor 11 used to connect the capacitor in parallel with the interrupter. The series connection of the capacitor and the inductance is configured to create an oscillating current superimposed on a DC current through the interrupter for breaking at zero-crossing of the current through the interrupter enabling breaking of this current when the contacts 9, 10 are moved apart. The device has also a surge arrester 7 connected in parallel with the resonance circuit and configured to start to conduct when the voltage across the interrupter 1 has reached a certain value upon movement of the contacts 9, 10 apart and to conduct until the DC current has been commutated to an alternative second current path as described further below with reference to FIGS. 8-11. This commutation takes place as a consequence of the presence of said voltage across the interrupter in said first current path. The surge arrester is configured to start to conduct at a voltage being lower than the rated voltage of the interrupter, such as about 50 kV-200 kV for an interrupter with a rated voltage of 245 kV.

Examples of a possible interrupter is a 145 kV or 245 kV SF₆ gas circuit breaker with puffer technology. The interrupter has preferably a rating exceeding 100 kV, such as in the range of 100 kV-500 kV.

Accordingly, the device according to the embodiment of the present invention shown in FIG. 5 has only a passive resonance circuit enabled by selection of a relationship of the capacitance in μF to the inductance in μH thereof as ≧1 still enabling breaking of currents exceeding 2500 A. There is only a control unit 12 for controlling the opening of the interrupter to take place upon occurrence of any event, such as a failure, making this required or just desired.

FIG. 6 illustrates a device according to a second embodiment of the invention differing from the embodiment shown in FIG. 5 only by the arrangement of two interrupters 1a, 1b in series. This series connection shall be understood as a series connection of two arcs formed upon separation of two couples of contacts when breaking a current. Thus, it may be a question of two separate interrupters connected in series or an interrupter having two chambers with contacts connected in series. This embodiment results in a higher arc voltage, a higher probability to create a voltage step that initiates the current oscillation and gives an increased withstand capability during the transient recovery phase with respect to the embodiment shown in FIG. 5. Series connection of the complete unit can also be possible as well as the series connection shown in FIG. 6.

A third embodiment of a device according to the present invention is shown in FIG. 7, and this differs from the embodiment shown in FIG. 5 by the fact that the resonance circuit comprises a switch 6 connected in series with the capacitor and the inductance and configured to be open when the interrupter is in a closed conducting state. The control means 12 is adapted to control the switch 6 to close and by that to close the resonance circuit with a delay, such as 15 ms after, with respect to a contact separation during an opening of the interrupter. This makes it possible to create a rather well defined voltage step that initiates the current oscillation in the resonance circuit. It is pointed out that the embodiment shown in FIG. 7 may of course have more than one interrupter or arcs created upon opening connected in series.

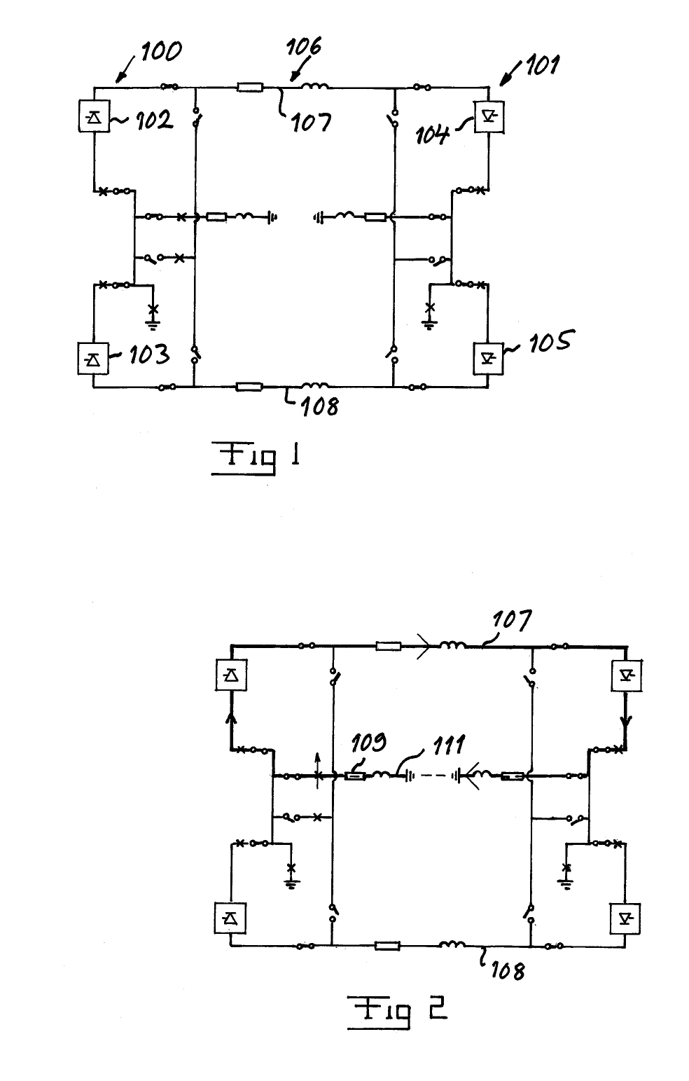

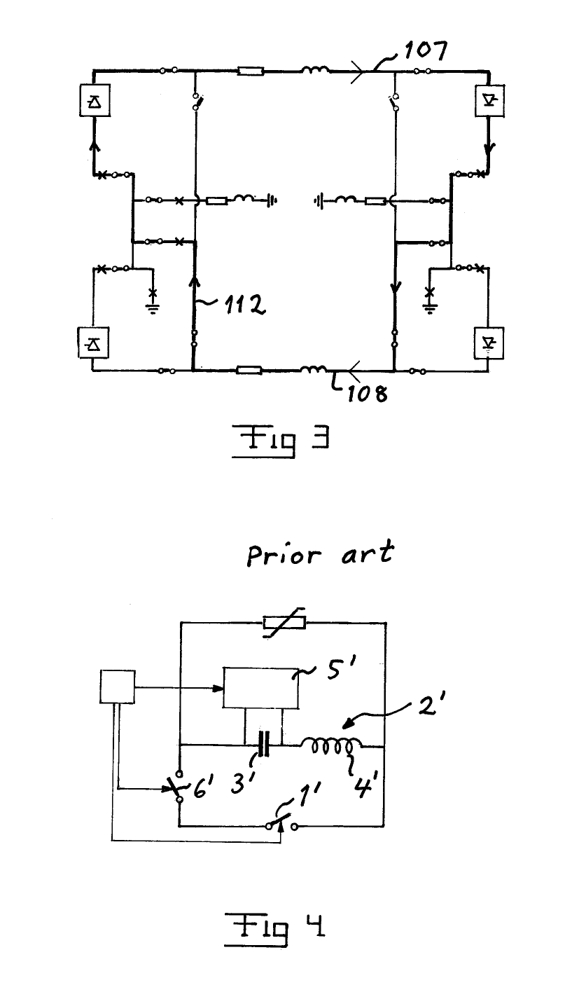

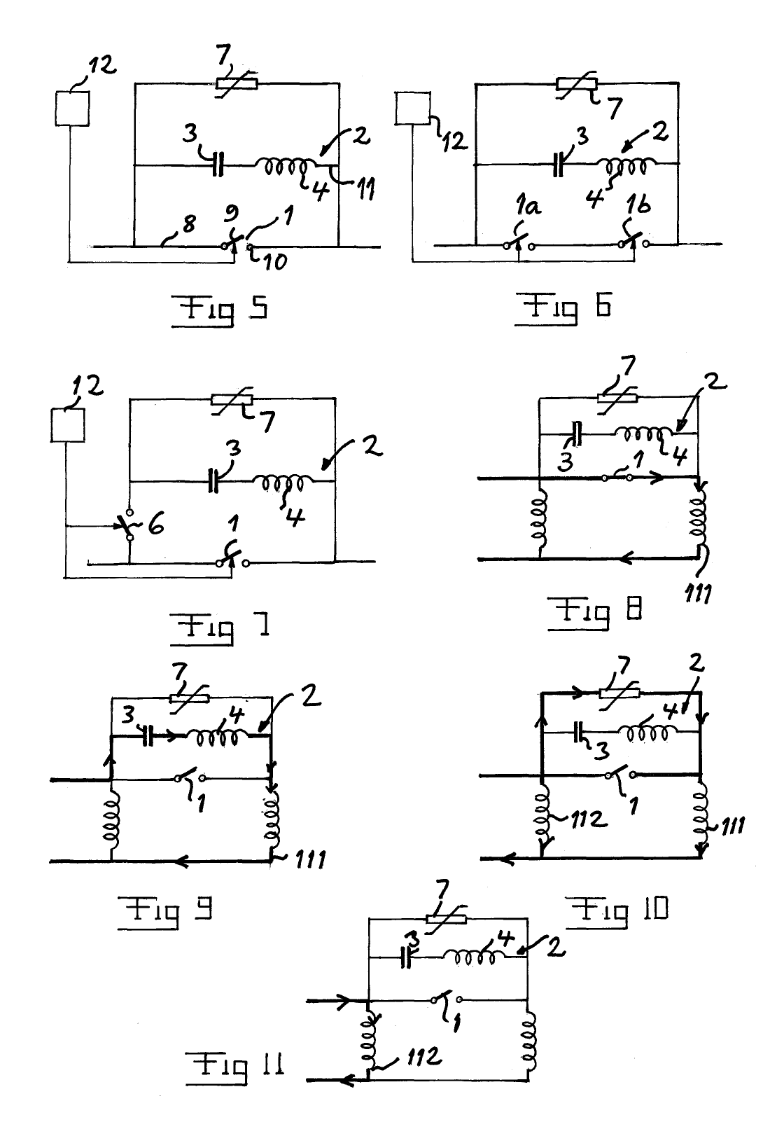

The sequence of breaking a DC current flowing in a first current path through an interrupter in a device according to the present invention and transferring this DC current to an alternative second current path will now be explained with reference made to FIGS. 8-11 and under the assumption that this device constitutes a metallic return transfer breaker in a plant as shown in FIGS. 1-3.

It is shown in FIG. 8 how the current flows through the interrupter and the inductance 110 of the ground path 111 when the contacts of the interrupter are closed and a failure has occurred, as shown in FIG. 2. From the instant the interrupter has started to open an oscillating current is created through the resonance circuit superimposed on the DC current through the interrupter. The amplitude of the injected oscillating current has to be higher than the DC current for obtaining a zero-crossing of the combined current. The injected oscillating current may be calculated while using the expression below if losses are neglected:

$${i}_{inject} ( t ) = {U}_{arc} \sqrt{\frac{C}{L}} sin ( ω \cdot t ) \qquad ( 1 )$$

in which

$$ω = \frac{1}{\sqrt{LC}} \qquad ( 2 )$$

in which ω is the angular resonance frequency, L the inductance of the resonance circuit, C the capacitance of the capacitor and U_{arc} the arc voltage.

Thus, the amplitude of said current will be increased with an increased value of the relationship of C to L.

The injected oscillating current i_{inject} has to be larger than the DC current I_{dc} through the interrupter to achieve a current zero-crossing, i.e.

$${U}_{arc} \sqrt{\frac{C}{L}} > {I}_{dc} \qquad ( 3 )$$

Thus, it has been realized that a high step in the arc voltage U_{arc} and a combination of “large” capacitance and “small” inductance are key parameters for breaking high DC currents.

Furthermore, the resonance frequency of the oscillating current or the time derivative of the oscillating current has to be low enough in relation to thermal time constants of the arc for a successful current interruption. This means that a maximum resonance frequency will set boundaries when selecting the capacitance and the inductance for the parallel resonance circuit. Previous designs have had a resonance frequency in the range of 4-5 kHz.

A further phenomenon to be considered is the rate of rise of a recovery voltage created when separating the contacts of the interrupter. The rate of rise for the transient recovery voltage has to be considered for preventing breakdown. The equation (4) below gives the rate of rise of the recovery voltage U_{TRV} depending on the DC current I_{dc} and capacitance C of the parallel resonance circuit:

$$\frac{d {U}_{TRV}}{d t} = \frac{{I}_{dc}}{C} \qquad ( 4 )$$

This implies that a “large” capacitance is reducing the recovery voltage rate of rise for a given DC current.

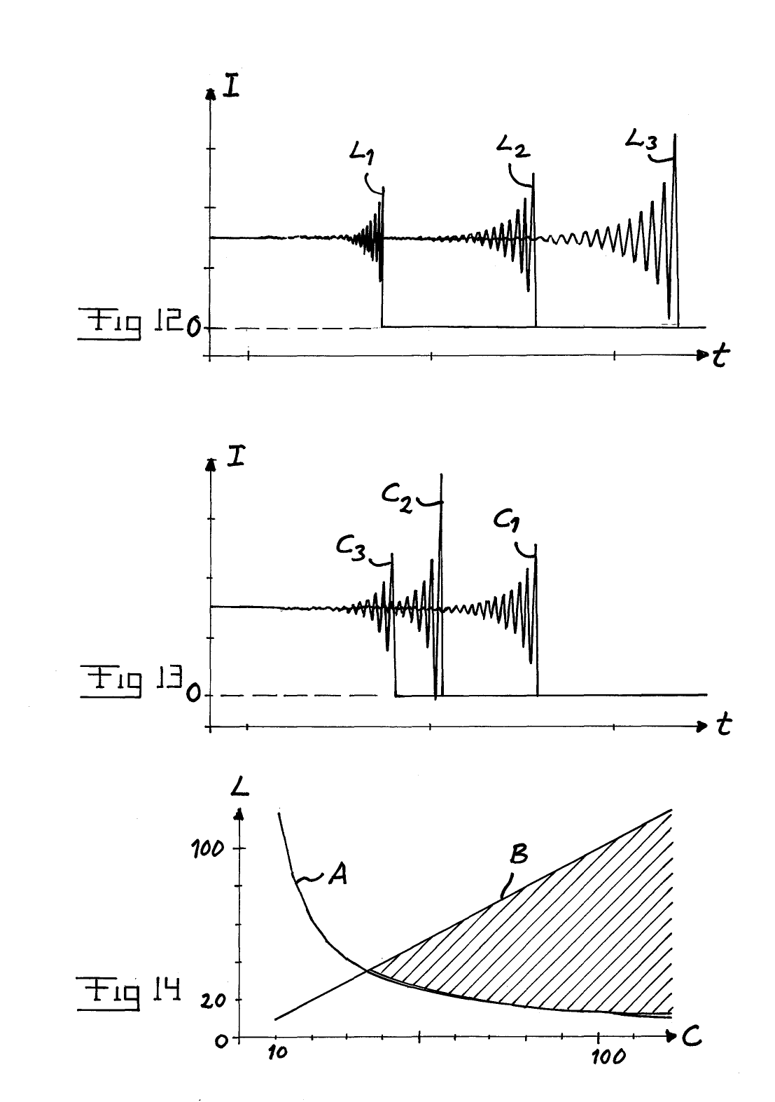

The DC current will in the state shown in FIG. 9 charge the capacitor and the voltage across the capacitor and the interrupter will increase. The current through the inductance of the new path is slowly increasing when the voltage across the interrupter is increasing. The voltage across the interrupter increases until the protective voltage level of the surge arrester 7 is reached. The voltage across the interrupter is then kept constant and equal to the surge arrester voltage until the DC current is commutated to the metallic return path 112 as shown in FIG. 11 as a consequence of the presence of the voltage across the surge arrester and by that across the interrupter in said first current path. The time from interruption at a current zero crossing until the surge arrester starts to conduct may typically be in the order of 1 ms and the time during which the surge arrester conducts may typically be in the order of 100 ms. Computer simulations have been carried out for investigating the influence of capacitance and inductance of a resonance circuit in a device according to the embodiment of the present invention shown in FIG. 5.

Three computer simulations have firstly been carried out with different inductances but the same capacitance for a DC current of 3 kA. The values of capacitance and inductance were as follows:

### C=20 μF

### L1=15 μH

### L2=60 μH

### L3=120 μH.

The diagram in FIG. 12 illustrates the current I versus time through the interrupter for these three cases. It appears that increasing the inductance reduces the resonance frequency, but the time until a zero-crossing occurs will increase.

Corresponding simulations for a constant inductance and different capacitances show that the highest capacitance gives the fastest current interruption and lowest resonance frequency, since a large capacitance makes it possible to improve two important properties, namely a lower resonance frequency and a high amplitude of an oscillating current.

Three simulations have been performed with different capacitances and inductances but the same resonance frequency for a DC current of 3 kA according to the values below:

### C1=20 μF and L1=60 μH

### C2=40 μF and L2=30 μH

### C3=60 μF and L3=20 μH

Accordingly, the resonance frequency is kept constant.

FIG. 13 shows a diagram of the DC current with superimposed oscillating current versus time for these three cases. It is shown how the fastest current interruption is achieved for the case with the highest capacitance.

Thus, it may be concluded that it is positive to have a high relationship of the capacitance to the inductance of the resonance circuit for obtaining a high amplitude of the oscillating current and a high capacitance for restricting the rate of rise of recovery voltage for preventing breakdown after interruption.

FIG. 14 illustrates how the inductance and the capacitance of a resonance circuit in a device according to the present invention may be selected for obtaining the properties requested in a device according to the invention. The inductance L is shown versus the capacitance C and the line A corresponds to a maximum resonance frequency of 4.5 kHz. Accordingly, lower frequencies are found by combinations of the capacitance and the inductance above this line A. Furthermore, the amplitude of said oscillating current is given by the relationship of the capacitance to the inductance, which according to the present invention should be at least 1. The straight line B corresponds to such a relationship of 1. This means that the two demands on amplitude and frequency of the oscillating current result in a possible area G shown by dashing in FIG. 14 for combinations of the capacitance and the inductance.

The invention is of course not in any way restricted to the embodiments described above, but many possibilities to modifications thereof should be apparent to a person with ordinary skill in the art without departing from the scope of the invention as defined in the appended claims.

The delay of the closing of the switch in the embodiment according to FIG. 7 may be any deemed to be suitable, such as for example 5 ms or 10 ms.

1. A device configured to break DC currents exceeding 2500 A flowing in a first current path and to transfer said DC currents to an alternative second current path, said device comprising:
at least one interrupter to be arranged in said first current path and having contacts movable with respect to each other from a closing to an opening position of the interrupter for breaking a current flowing therethrough;
a resonance circuit connected in parallel with said interrupter and comprising a capacitor and an inductance connected in series and configured to create an oscillating current superimposed on said DC current for creating a zero-crossing of the current flowing through the interrupter, thereby enabling breaking of this current when said contacts are moved apart; and
a surge arrester connected in parallel with said resonance circuit and configured to start to conduct when the voltage across said interrupter has reached a certain value upon movement of said contacts apart and to conduct until said DC current has been commutated to said alternative second current path connected to said first current path as a consequence of the presence of said voltage across said interrupter in said first current path, wherein the relationship of the capacitance in μF to the inductance in μH of said resonance circuit is >1.

2. The device according to claim 1, wherein said relationship is >2.

3. The device according to claim 1, wherein said relationship is <8.

4. The device according to claim 1, wherein said relationship is between 3 and 6.

5. The device according to claim 1, wherein said inductance of the resonance circuit is formed solely by the self inductance of a conductor used to connect said capacitor in parallel with said interrupter.

6. The device according to claim 1, wherein said inductance of said resonance circuit is between 5 and 35 μH or between 15 and 25 μH.

7. The device according to claim 1, wherein the capacitance of the resonance circuit is between 40 and 80 μF or between 50 and 70 μF.

8. The device according to claim 1, wherein said inductance of the resonance circuit is between 15 and 25 μH and said relationship is between 2.5 and 3.5.

9. The device according to claim 1, wherein said resonance circuit is purely passive.

10. The device according to claim 1, wherein the device has only one said interrupter connected in parallel with said resonance circuit.

11. The device according to claim 1, wherein the device has two or more said interrupters connected in series, and the series connection of said interrupters is connected in parallel with said resonance circuit.

12. The device according to claim 1, wherein said resonance circuit comprises a switch connected in series with said capacitor and said inductance and configured to be open when said interrupter is in a closed conducting state, and that the device further comprises means configured to control said switch to close and by that to close said resonance circuit with a delay with respect to said opening of said interrupter.

13. A method of using the device according to claim 1 for breaking a DC current I, in which 2500 A<I<7000 A.

14. A plant for transmitting electric power through High Voltage Direct Current (HVDC) having in at least one converter station thereof a device according to claim 1 for commutating a DC current flowing in a first current path of said plant into an alternative second current path thereof.

15. The plant according to claim 14, wherein said plant has a bipole direct current line interconnecting two said converter stations thereof, and said device is arranged in a ground return path used by said DC current upon failure in connection with one of the two poles of the direct current line and to commutate said DC current to flow through a metallic return path between said stations.

16. The device according to claim 2, wherein said relationship is between 2 and 8.

17. The device according to claim 2, wherein said relationship is between 2.5 and 3.5.

18. The device according to claim 3, wherein said relationship is between 2.5 and 3.5.

19. The device according to claim 2, wherein said inductance of the resonance circuit is formed solely by the self inductance of a conductor used to connect said capacitor in parallel with said interrupter.

20. The device according to claim 3, wherein said inductance of the resonance circuit is formed solely by the self inductance of a conductor used to connect said capacitor in parallel with said interrupter.
